(19) United States
(12) Patent Application Publication
(10) Pub. No.: US 2012/0154344 A1
(43) Pub. Date: Jun. 21, 2012

(54) ELECTRIC PAPER DISPLAY APPARATUS

(75) Inventors: Chih-Yu Peng, Hsinchu (TW); Wei-Chen Tsai, Hsinchu (TW); Lee-Tyng Chen, Hsinchu (TW)

(73) Assignee: E Ink Holdings Inc., Hsinchu City (TW)

(21) Appl. No.: 13/090,901

(22) Filed: Apr. 20, 2011

(30) Foreign Application Priority Data
Dec. 15, 2010 (TW) 099143994

(51) Int. Cl. G09G 5/00

(52) U.S. Cl. 345/204

(57) ABSTRACT

An electric paper display apparatus includes a substrate, a display layer and a protective layer. The display layer is disposed on the substrate. The protective layer is disposed on the display layer. The protective layer includes a bottom surface facing to the display layer and a plurality of color filter patterns disposed on the bottom surface. It does not need to dispose a color filter substrate on the protective layer of the electric paper display apparatus, so a cost and a thickness of the electric paper display apparatus can be reduced.

### FIELD OF THE INVENTION

The present invention relates to a display apparatus, and more particularly to an electric paper display apparatus.

### BACKGROUND OF THE INVENTION

With the coming of information age, the display apparatuses have become one of the indispensable electronic products of modern life. The display apparatus has developed from the traditional cathode ray tube (CRT) display apparatus to the present liquid crystal display (LCD) apparatus which is light in weight and thin in thickness. Due to the advantages, the LCD apparatus is widely used in communication, information and consumption electronic products. However, the LCD apparatus needs continuous power for operation, and further needs a back light module for displaying. Moreover, the LCD apparatus could not be read under high light environment. Therefore, the electric paper display apparatus is developed for saving energy.

The common electric paper display apparatus mainly displays monochrome images. In order to enable the electric paper display apparatus to display color images, an additional color filter substrate should be applied to the monochrome electric paper display apparatus. However, because the color filter substrate includes a glass substrate and a plurality of color photoresists formed on the glass substrate, after the color filter substrate is applied, the glass substrate decreases the optical properties of the electric paper display apparatus, and increases the thickness of the electric paper display apparatus. Moreover, additional adhering process, adhering apparatus and material cost are needed for adhering the color filter substrate, so the manufacturing cost of the electric paper display apparatus is increased.

Therefore, it is important to simplify the manufacturing process and reduce the manufacturing cost of an electric paper display apparatus capable of displaying color images.

### SUMMARY OF THE INVENTION

The present invention provides an electric paper display apparatus with low cost and thin thickness.

In order to achieve the above-mentioned advantages, the present invention provides an electric paper display apparatus, which includes a substrate, a display layer and a protective layer. The display layer is disposed on the substrate. The protective layer is disposed on the display layer. The protective layer includes a bottom surface facing to the display layer and a plurality of color filter patterns disposed on the bottom surface.

In one embodiment of the present invention, the color filter patterns include a plurality of color photoresists with various colors.

In one embodiment of the present invention, the protective layer further includes a black matrix disposed on the bottom surface for separating the color filter patterns.

In one embodiment of the present invention, the electric paper display apparatus further includes a sealant disposed between the substrate and the protective layer, and the display layer is surrounded by the sealant.

In one embodiment of the present invention, material of the sealant is ultraviolet cured adhesive.

In one embodiment of the present invention, the substrate is an active element array substrate.

In one embodiment of the present invention, the substrate is a passive element substrate.

In one embodiment of the present invention, the substrate is a glass substrate or a metallic substrate.

In one embodiment of the present invention, the substrate is a flexible substrate.

In one embodiment of the present invention, the display layer is a cholesteric liquid crystal display layer, an electrophoretic display layer, an electrowetting display layer, or a quick response liquid powder display layer.

In the electric paper display apparatus of the present invention, the color filter patterns are integrated into the protective layer, and therefore it does not need to dispose a conventional color filter substrate on the protective layer. Thus, the electric paper display apparatus capable of displaying color images can be obtained without performing complicated processes for disposing the conventional color filter substrate on the display layer. Such that, the manufacturing processes and related manufacturing apparatuses for the conventional color filter substrate can be omitted, so the manufacturing cost of the electric paper display apparatus of the present invention can be reduced. Furthermore, as compared to the conventional electric paper display apparatus having the additional color filter substrate, the thickness of the electric paper display apparatus of the present invention is greatly reduced.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of an electric paper display apparatus according to an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

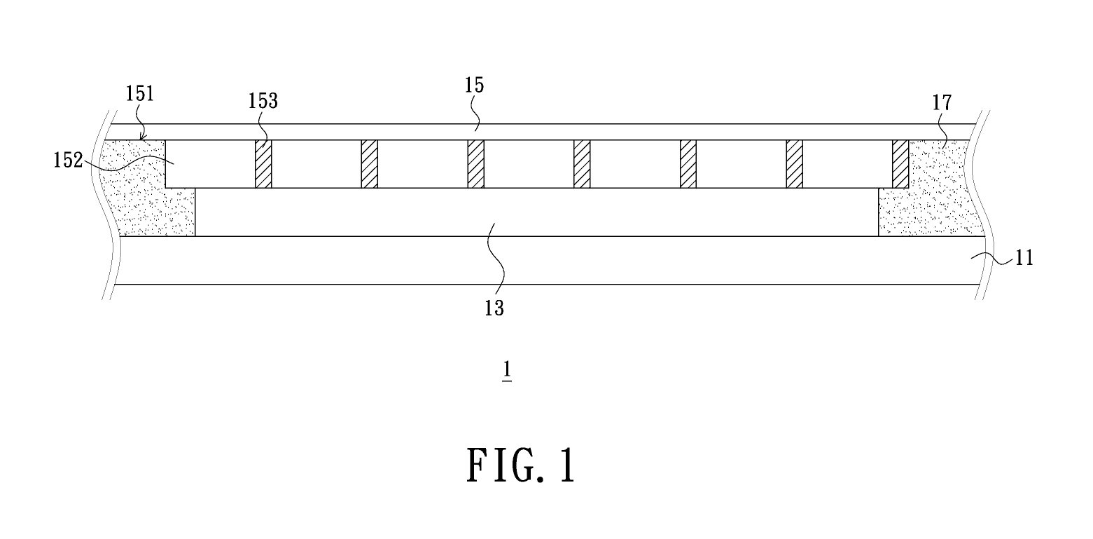

FIG. 1 is a schematic view of an electric paper display apparatus according to an embodiment of the present invention. Referring to FIG. 1, the electric paper display apparatus 1 of the present embodiment includes a substrate 11, a display layer 13 and a protective layer 15.

The substrate 11 may be a flexible substrate, i.e., the electric paper display apparatus 1 may be a flexible display apparatus. However, in other embodiments, the substrate 11 may be a rigid substrate. More concretely, the substrate 11 may be a glass substrate, a metallic substrate, or a plastic substrate. Moreover, in this embodiment, the substrate 11 may be, but not limited to, an active element array substrate such as a thin film transistor array substrate. In other embodiments of the present invention, the substrate 11 may be a passive element substrate.

The display layer 13 is disposed on the substrate 11. The display layer 13 may be, but not limited to, a cholesteric liquid crystal display layer, an electrophoretic display layer, an electrowetting display layer, or a quick response liquid powder display layer.

The protective layer 15 is disposed on the display layer 13. The protective layer 15 can be a flexible film. The protective layer 15 includes a bottom surface 151 facing to the display layer 13 and a plurality of color filter patterns 152 disposed on the bottom surface 151. That is, the color filter patterns 152 are formed on the bottom surface 151 of the protective layer 15. The color filter patterns 152 are, for example, arranged in an array, and the color filter patterns 152 are, for example, a plurality of color photoresists with various colors. For example, the color filter patterns 152 may include red photoresists, green photoresists and blue photoresists. The arrangement manner of the color photoresists is known by one skilled in the art, and therefore detailed descriptions are omitted. Moreover, the protective layer 15 can further include a black matrix 153 disposed on the bottom surface 151 for separating the color filter patterns 152. The black matrix 153 can prevent light rays passed through adjacent color filter patterns 152 from interfering with each other.

The electric paper display apparatus 1 of the present embodiment, for example, further includes a sealant 17. The sealant 17 is disposed between the substrate 11 and the protective layer 15, and the display layer 13 is surrounded by the sealant 17. Furthermore, the protective layer 15 can be firmly fixed to the substrate 11 by the sealant 17. In the present embodiment, material of the sealant 17 may be ultraviolet cured adhesive (or named UV adhesive), which may be cured because of polymerization reaction generated under irradiation of ultraviolet ray.

As compared to the conventional technique of adhering the additional color filter substrate to the protective layer, due to the protective layer 15 of the electric paper display apparatus 1 of the present embodiment having the color filter patterns 152, the protective layer 15 can be directly disposed on the display layer 13 to realize color display effect. Because it does not need to additionally dispose the conventional color filter substrate on the protective layer 15, the manufacturing processes and the related manufacturing apparatuses for the conventional color filter substrate can be omitted. Therefore, the manufacture cost of the electric paper display apparatus 1 of the present embodiment can be reduced. Moreover, in the conventional color filter substrate, the glass substrate has greater thickness. However, the present embodiment does not need the conventional color filter substrate, so the thickness of the electric paper display apparatus 1 can be greatly reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electric paper display apparatus, comprising:
a substrate;
a display layer disposed on the substrate; and
a protective layer disposed on the display layer and comprising a bottom surface facing to the display layer and a plurality of color filter patterns disposed on the bottom surface.

2. The electric paper display apparatus according to claim 1, wherein the color filter patterns comprise a plurality of color photoresists with various colors.

3. The electric paper display apparatus according to claim 1, wherein the protective layer further comprises a black matrix disposed on the bottom surface for separating the color filter patterns.

4. The electric paper display apparatus according to claim 1 further comprising a sealant disposed between the substrate and the protective layer, wherein the display layer is surrounded by the sealant.

5. The electric paper display apparatus according to claim 4, wherein material of the sealant is ultraviolet cured adhesive.

6. The electric paper display apparatus according to claim 1, wherein the substrate is an active element array substrate.

7. The electric paper display apparatus according to claim 1, wherein the substrate is a passive element substrate.

8. The electric paper display apparatus according to claim 1, wherein the substrate is a glass substrate or a metallic substrate.

9. The electric paper display apparatus according to claim 1, wherein the substrate is a flexible substrate.

10. The electric paper display apparatus according to claim 1, wherein the display layer is a cholesteric liquid crystal display layer, an electrophoretic display layer, an electrowetting display layer, or a quick response liquid powder display layer.
